(19) United States
(12) Patent Application Publication
(10) Pub. No.: US 2016/0078208 A1
(43) Pub. Date: Mar. 17, 2016

(54) DEVICE AND MANAGEMENT MODULE

(71) Applicants: Hitoshi NAMIKI, Kanagawa (JP); Naoya MORITA, Kanagawa (JP)

(72) Inventors: Hitoshi NAMIKI, Kanagawa (JP); Naoya MORITA, Kanagawa (JP)

(73) Assignee: RICOH COMPANY, LTD., Tokyo (JP)

(21) Appl. No.: 14/845,415

(22) Filed: Sep. 4, 2015

(30) Foreign Application Priority Data
Sep. 11, 2014 (JP) 2014-184965

(51) Int. Cl. G06F 21/31; G06F 21/62

(52) U.S. Cl. CPC G06F 21/31; G06F 21/6218

(57) ABSTRACT

A device holding control target data inside, includes a state management unit configured to manage the present life cycle state of the device; a user authentication unit configured to authenticate a user and output a group of the user; and an access control unit configured to acquire a present life cycle state when an access request to access the control target data is received, acquire the group of the authenticated user, acquire access possibility information based on the present life cycle state and the group of the user, and control access to the control target data based on the access possibility information. The state management unit manages a fixed life cycle state, and a variable life cycle state that can be added, changed, or deleted, and the access control unit implements control on the fixed life cycle state before the variable life cycle state.

### BACKGROUND OF THE INVENTION

1. Field of the Invention

The present invention relates to a device and a management module.

2. Description of the Related Art

In the technical field of embedded devices, important electronic information is stored in the embedded device, and high-level security for protecting the electronic information is becoming necessary. Here, an embedded device is formed by embedding a module having a computer function in a device such as a vehicle, a home electric appliance, a machine, etc., in order to realize a particular function.

Furthermore, in an embedded device, there is demand to maintain the safety of the electronic information throughout the life cycle, including the respective stages from manufacturing to disposing, that is, to consistently maintain the safety of the electronic information in the device. For example, when the main user is changed according to the life cycle, it is highly necessary to secure the safety of the electronic information.

There is known a technology for the purpose of preventing unauthorized usage of an IC card, in which a function is provided for confirming whether there is a setting of security data when changing the life cycle state of the IC card, and state transition is performed only when the security data is set.

However, the technology of managing the life cycle as states and preventing unauthorized usage according to the management, has been possible in a simple device such as an IC card, but has been difficult to apply to a general-purpose embedded device, from the viewpoint of coexistence of personal information of multiple persons, access control depending on the personal information of multiple persons, and preventing unauthorized usage.

First, an IC card is assumed to be used by a single user; however, when the life cycle is to be managed as states with respect to an embedded device having a general data storage, the user is not necessarily a single user. There are cases where the user is assumed to be substantially a single user such as a mobile phone; however, there are devices that are assumed to be used a plurality of users such as a printer located in an office. Furthermore, there are cases where the same embedded device is used in different ways, such as a vehicle, which may be used by a single user, or rented and rented out as a rental car, or owned by a plurality of persons in car sharing. With respect to these embedded devices, it is very difficult to secure the safety throughout the life cycle simply by setting a key or a PIN (Personal Identification Number); security can be assured only by managing the confidential information of each user and applying an appropriate access restriction with respect to the data in the embedded device according to the life cycle.

Furthermore, only by the measure of checking whether there is a setting of information before activating the application as in the example of an IC card, the embedded device can be accessed by the setting person who implemented the state transition, after the setting person has transferred the embedded device to a user. That is, the user needs to trust the setting person who implemented the state transition, assuming that the setting person will not use the IC card in an unauthorized manner. Specifically, when the life cycle state is transited, both the setting person who implemented the state transition and the user who receives the embedded device after the state transition may access the information in the embedded device, and the access cannot be controlled such that only the user is able to handle the information after the state transition. Thus, there has been leeway for unauthorized usage.

Furthermore, there have been problems with respect to the types of life cycle states. In the case of an IC card, the method of usage is substantially fixed, and therefore the method of applying a restriction to the life cycle state transition has been fixed, by setting a key or a PIN. However, among embedded devices having a data storage, there are cases where the types of life cycles are completely different according to the operation methods. For example, in the case of a vehicle, a vehicle used by an individual and a vehicle that is rented are operated by completely different methods.

However, there is a problem in a measure of manufacturing a safe embedded device for each delivery, simply by making it possible to change the condition relevant to the life cycle state, by software after the delivery.

First, in order to maintain the security of an embedded device, the security needs to be assured based on the close relationship between the security and the life cycle, such as changing the access control to the data with respect to the embedded device according to the life cycle, and also to performing operations of erasing the data, etc., according to changes in the life cycle.

However, when the relationship between security and the life cycle is changed afterwards by software, the relationship between the security and the life cycle is changed. In such a state, there is no way of assuring that the embedded device is really safe throughout the life cycle. For example, it is assumed that there is an embedded device that assures the safety in a disposed state, by applying a life cycle state of finally disposing the embedded device and deleting all data of the embedded device. However, when life cycle state data is added afterwards to the embedded device such that the embedded device does not reach a stage of being disposed, it is not assured that the data is erased at the time of disposal, and it will not be possible to confirm whether the embedded device is safe at the time of being disposed, which leads to a defect in security.

That is, in order to assure the safety of the embedded device throughout the life cycle, the personal information needs to be appropriately managed, other than simply using a key or a PIN. Furthermore, it is preferable to be able to set the life cycle state for each delivery destination; however, the fact that the life cycle state can be set may become a loophole in the security of the embedded device that is managed based on the life cycle, and there is a need to construct a security system in consideration of these aspects.

Patent Document 1: Japanese Laid-Open Patent Publication No. 2009-75968

### SUMMARY OF THE INVENTION

The present invention provides a device and a management module, in which one or more of the above-described disadvantages are eliminated.

According to an aspect of the present invention, there is provided a device holding control target data inside the device, the device including a state management unit configured to manage a life cycle state that the device is presently in; a user authentication unit configured to receive authentication data, authenticate a user, and give a response indicating a group to which the user belongs; and an access control unit configured to acquire a present life cycle state from the state management unit when an access request to access the control target data is received, authenticate the user by the user authentication unit and acquire the group of the authenticated user, acquire access possibility information based on the present life cycle state and the group of the user who has made the access request, the access possibility information being acquired from a state access control policy associated with the control target data, and control access to the control target data based on the access possibility information, wherein the state management unit manages a fixed life cycle state and a variable life cycle state having a parent that is one of the fixed life cycle states, wherein the variable life cycle state can be added, changed, or deleted, and the access control unit implements control with respect to the fixed life cycle state before the variable life cycle state.

According to an aspect of the present invention, there is provided a management module installed in a device holding control target data inside the device, the management module including a state management unit configured to manage a life cycle state that the device is presently in; a user authentication unit configured to receive authentication data, authenticate a user, and give a response indicating a group to which the user belongs; and an access control unit configured to acquire a present life cycle state from the state management unit when an access request to access the control target data is received, authenticate the user by the user authentication unit and acquire the group of the authenticated user, acquire access possibility information based on the present life cycle state and the group of the user who has made the access request, the access possibility information being acquired from a state access control policy associated with the control target data, and control access to the control target data based on the access possibility information, wherein the state management unit manages a fixed life cycle state and a variable life cycle state having a parent that is one of the fixed life cycle states, wherein the variable life cycle state can be added, changed, or deleted, and the access control unit implements control with respect to the fixed life cycle state before the variable life cycle state.

According to an aspect of the present invention, there is provided a non-transitory computer-readable recording medium storing a program that causes a computer that constitutes a management module installed in a device holding control target data inside the device, to execute a process including managing a life cycle state that the device is presently in; receiving authentication data, authenticating a user, and giving a response indicating a group to which the user belongs; acquiring a present life cycle state managed at the managing when an access request to access the control target data is received, authenticating the user and acquiring the group of the authenticated user, acquiring access possibility information based on the present life cycle state and the group of the user who has made the access request, the access possibility information being acquired from a state access control policy associated with the control target data, and controlling access to the control target data based on the access possibility information, wherein the managing includes managing a fixed life cycle state and a variable life cycle state having a parent that is one of the fixed life cycle states, wherein the variable life cycle state can be added, changed, or deleted, and the controlling includes implementing control with respect to the fixed life cycle state before the variable life cycle state.

### BRIEF DESCRIPTION OF THE DRAWINGS

Other objects, features and advantages of the present invention will become more apparent from the following detailed description when read in conjunction with the accompanying drawings, in which:

FIG. 1 illustrates an example of a life cycle;

FIG. 2 illustrates an embedded device according to an embodiment;

FIG. 3 illustrates examples of fixed life cycle states and variable life cycle states;

FIG. 4 illustrates a life cycle state management module according to an embodiment;

FIG. 5 illustrates a control module according to an embodiment;

FIG. 6 is a functional block diagram of a life cycle state management module according to an embodiment;

FIG. 7 illustrates an example of stored data;

FIG. 8 is a functional block diagram of a control module according to an embodiment;

FIGS. 9A through 9F illustrate examples of state access control policies;

FIGS. 10A and 10B illustrate an example where a new state has been added to the state access control policy;

FIGS. 11A and 11B illustrate an example where a new group has been added to the state access control policy;

FIG. 12 is a flowchart illustrating an access process to control target data;

FIG. 13 is a flowchart of a process for checking whether the user has an access authority to the data under the life cycle state management;

FIG. 14 is a flowchart of process of changing the life cycle state;

FIG. 15 illustrates a specific example of using the variable life cycle state (part 1);

FIG. 16 illustrates a specific example of using the variable life cycle state (part 2); and

FIG. 17 illustrates a specific example of using the variable life cycle state (part 3).

### DETAILED DESCRIPTION OF THE PREFERRED EMBODIMENTS

A description is given, with reference to the accompanying drawings, of embodiments of the present invention.

### EMBODIMENT

### Life Cycle

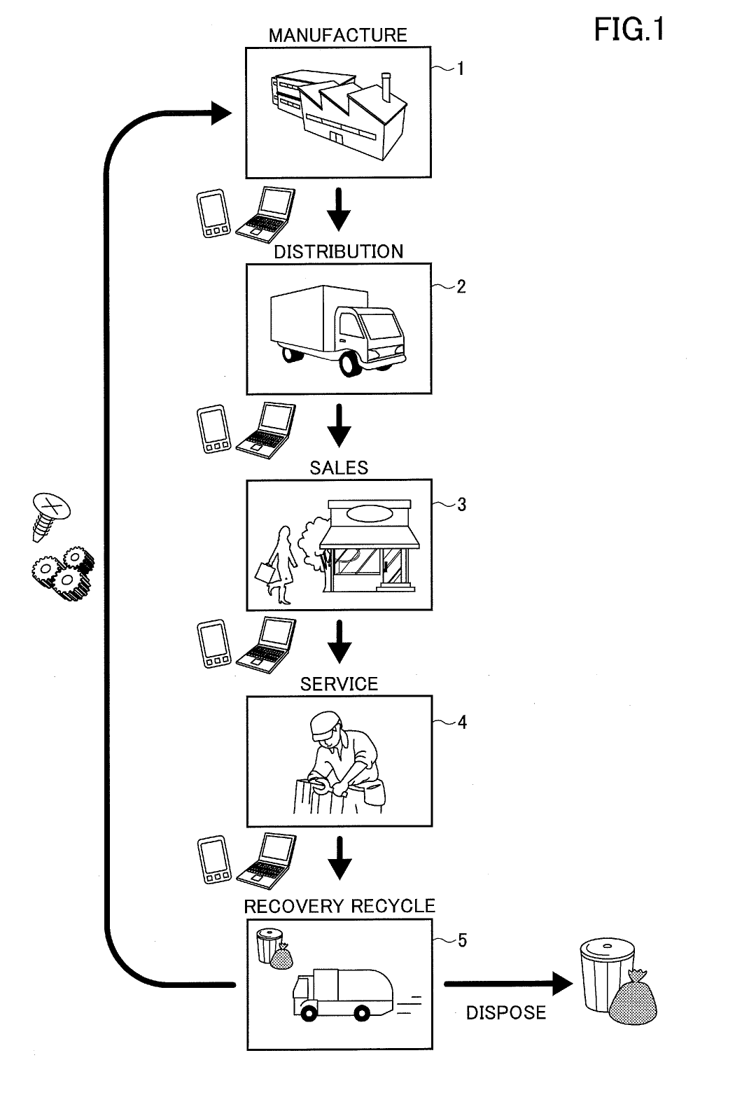

FIG. 1 illustrates an example of a life cycle of an embedded device. The life cycle states of an embedded device do not only include the process where the user simply uses the embedded device, but also include a manufacture stage 1 of manufacturing the embedded device at the factory, a distribution stage 2 of conveying the embedded device with a transportation means such as a truck for selling the embedded device, and a sales stage 3 of selling the embedded device at an outlet store. Furthermore, the life cycle states of the embedded device include a service stage 4 of providing a service such as repairing the embedded device when the embedded device breaks down while being used by the user, and a recovery recycle stage 5 of recovering and recycling the embedded device from the viewpoint of environmental protection. Depending on the embedded device, there may be a dispose stage of disposing the embedded device in addition to or instead of the recovery recycle stage.

The life cycle illustrated in FIG. 1 may differ according to the delivery destination such as the country and area; however, in the present embodiment, as one example, the operations of the embedded device throughout these stages are collectively referred to as a life cycle. For example, control is implemented such that the life cycle is operated through a proper route (through proper stages) and it is proven that the life cycle is operated properly, in order to reliably recover and recycle the embedded device and to prevent the embedded device from being wrongfully used, from the viewpoint of environmental protection.

### <Embedded Device>

A description is given of an embedded device (hereinafter, “device”) such as a vehicle provided with a life cycle state management function, as an example of a device in which a life cycle state management function is installed.

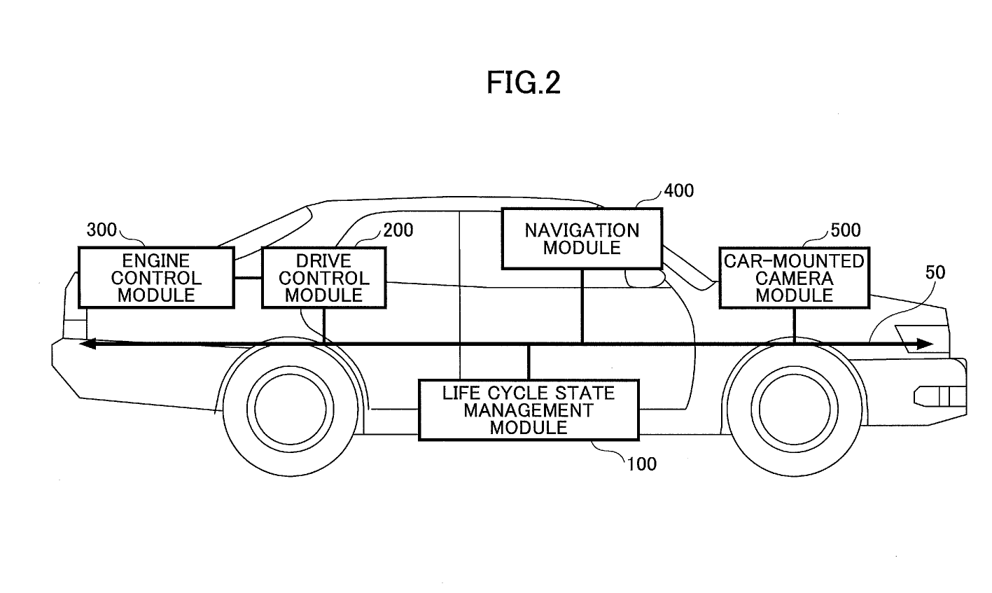

FIG. 2 illustrates a control module configuration of a vehicle provided with a life cycle state management function according to an embodiment. The vehicle according to the present embodiment is constituted by a life cycle state management module 100 for managing the stages (states) of the life cycle of the entire vehicle, and one or more control modules storing data in which the access control policy is defined according to each stage of the life cycle. The life cycle state management module 100 and some of the one or more control modules constitute a network such as a CAN (Controller Area Network), a LIN (Local Interconnect Network), an Ethernet (registered trademark), a LAN (Local Area Network), etc., by being connected by a bus 50. The network is not limited to the above examples; the life cycle state management module 100 and one or more control modules may be connected by FlexRay. In the example of FIG. 2, the life cycle state management module 100 and some of the plurality of control modules are connected by the bus 50. FIG. 2 illustrates, as examples of the plurality of control modules, a drive control module 200, an engine control module 300, a navigation module 400, and a car-mounted camera module 500.

The life cycle state management module 100 manages the stages of a single life cycle with respect to the entire device, and also manages the authentication information of the device user. The life cycle state management module 100 recognizes the configuration of one or more control modules of the device, and gives control instructions to the one or more control modules. According to each stage of the life cycle, an access control policy (hereinafter, “state access control policy”) set according to each stage of the life cycle of the one or more control modules, is stored in the life cycle state management module 100. The life cycle state management module 100 gives control instructions based on the state access control policy of the control module that is the target of control, and receives requests from the control module that is the target of control, in each stage of the life cycle. According to a request from each control module, the life cycle state management module 100 reports the life cycle state of the device and the group to which the person who has made the access to use the device (hereinafter, “accessing person”), belongs, via the bus 50. Here, the group is for classifying the accessing persons from the viewpoint of access authority, and is used for determining whether the accessing person has the authority for access. A group may be set for people, or may be set for entities other than people such as a division in a company or a factory.

For example, it is assumed that the control instruction and data for the control module to which a salesman can access in the sales stage 3 of the life cycle, and the control instruction and data for the control module to which a mechanic can access when repair is necessary in the service stage 4 of the life cycle, have different contents. The life cycle state management module 100 manages the authentication information of the accessing person accessing the vehicle (salesman, mechanic), and associates the accessing person accessing the vehicle with the state access control policy. Accordingly, it is possible to prevent a situation where the salesman accesses the information necessary for repair, and damaging the information of the control module that is accessed when the mechanic repairs the vehicle.

The drive control module 200 implements drive control of the vehicle. The engine control module 300 controls the engine of the vehicle. The navigation module 400 performs navigation for guiding the vehicle to the destination. The car-mounted camera module 500 controls a camera mounted on the vehicle.

In the drive control module 200, the engine control module 300, the navigation module 400, and the car-mounted camera module 500, store data in which the state access control policy is defined. The state access control policy describes operations that can be accessed by the group, according to each stage in the life cycle.

The drive control module 200, the engine control module 300, the navigation module 400, and the car-mounted camera module 500 receive, from the life cycle state management module 100 according to need, the stage of the life cycle at that time point and the group of the accessing person, and determine whether access to the data is possible. Based on the stage in the life cycle, the groups that can access the respective control modules mounted on the vehicle are changed all at once. Therefore, it is possible to prevent a situation of forgetting to change the groups and incorrectly changing the groups, which are likely to occur in a case of making the changes one at a time.

Furthermore, when the life cycle state management module 100 stores data in which the access control policy is defined, there are cases where it is determined whether access to the data is possible, upon receiving the stage in the life cycle of the life cycle state management module 100 and the group of accessing person.

The life cycle state management module 100 and the control modules may be connected such that data can be directly exchanged via the bus 50, such as in the case of the life cycle state management module 100, the drive control module 200, the navigation module 400, and the car-mounted camera module 500. Furthermore, the life cycle state management module 100 may be connected with a particular control module such that data can be indirectly exchanged with another control module via the particular control module, such as in the case of the drive control module 200 and the engine control module 300. Furthermore, in addition to being connected via the bus 50, the life cycle state management module 100 and the control modules may be connected by a cable line such as a network cable or by a wireless network. In any case, there is demand to make a setting such that communication can be performed between the control modules according to a particular protocol.

As described above, the drive control module 200, the engine control module 300, the navigation module 400, and the car-mounted camera module 500 have a state access control policy, and each control module can individually confirm the access authority with respect to data. Other than the method of individually confirming the access authority by each control module, there is a method of providing information in the life cycle state management module 100, in which an identifier of the data held by each control module is associated with the state access control policy of the corresponding data. In this case, the life cycle state management module 100 determines whether there is an access authority based on the state access control policy associated with the data held by each control module, and reports the determination result to each control module. Each control module acquires the determination result sent from the life cycle state management module 100, and can perform operations such as allowing access to the data according to the determination result.

A device that is the target of installing a life cycle state management function indicates a group of all control modules controlled by a common life cycle. That is, when control modules in the vehicle are managed by the same life cycle, the vehicle is the device having the life cycle, and when control modules on a board loaded on a certain commercial material are managed by the same life cycle, the board is the device having the life cycle. This is particularly effective in a case where the shelf life of data stored in each control module installed in the device, matches the shelf life of the device.

### <Fixed Life Cycle State/Variable Life Cycle State>

The life cycle state management module 100 manages two types of life cycles, which are respectively referred to as a fixed life cycle state and a variable life cycle state. The respective life cycle states have the following properties.

Fixed life cycle state
Commonly applied to all delivery destinations, and cannot be changed.
An access control rule for maintaining security is applied in a fixed manner.

Variable life cycle state
The delivery destination can be changed, and the life cycle state can be added and deleted.
The access control rule to be defined for the variable life cycle state cannot grant a stronger authority than that of the fixed life cycle.
Exists only as a child state of the fixed life cycle state.

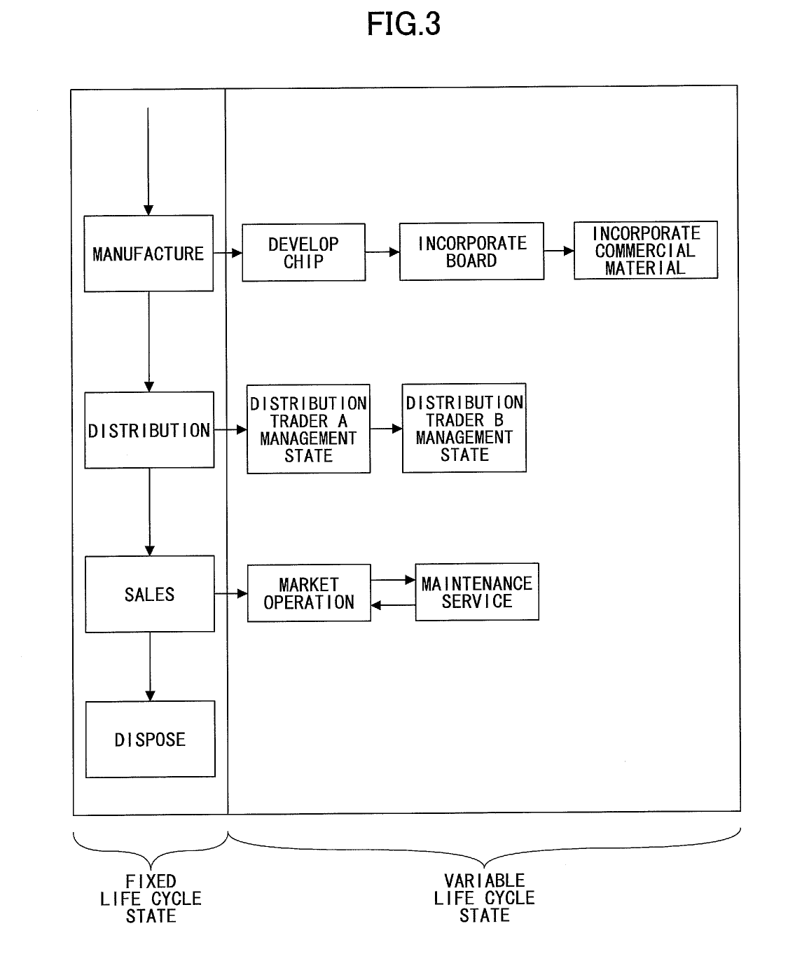

FIG. 3 illustrates examples of the fixed life cycle states and the variable life cycle states which are managed in the life cycle state management module 100. In the illustrated example, the fixed life cycle states are “manufacture”, “distribution”, “sales”, and “dispose”. The variable life cycle states are “develop chip”, “incorporate board”, and “incorporate commercial material” which are children of ““manufacture”; “distribution trader A management state” and “distribution trader B management state” which are children of “distribution”; and “market operation” and “maintenance service” are which children of “sales”. Note that as in the relationship between the market operation state and the maintenance service state that are the variable life cycle states, the state transmission may be performed to return to the original state in the variable life cycle states.

The life cycle state management module 100 holds two types of states, i.e., the fixed life cycle state at the time point and the variable life cycle state existing as a child of the fixed life cycle state. That is, the state of the device at a certain time point is expressed by a pair of what the fixed life cycle state is and what the variable life cycle state is. However, as in the case of the dispose state of FIG. 3, there may be cases where there is only a fixed life cycle state and there is no variable life cycle state.

When access is made to the data that is the management target of the life cycle state management module 100, first, the access control policy held by the fixed life cycle state is confirmed, and only when it is determined that access is possible as a result of the confirmation, the access control policy of the variable life cycle state is confirmed. Accordingly, the safety of the life cycle state management module 100 is assured by the fixed life cycle state, and it is possible to make settings for each delivery by the variable life cycle state. By confirming the access control policy of the fixed life cycle state before confirming the access control policy of the variable life cycle state, a restriction is applied to the access control policy that can be set for each variable life cycle state. By applying the restriction, it is possible to prevent a loophole from being created in the security, such as a rise in the authority which may be caused by setting the variable life cycle state.

With respect to the state transition of the life cycle, there are two types of state transition, i.e., the state transition between the variable life cycle states and the state transition between the fixed life cycle states. The state transition between the variable life cycle states is only performed between variable life cycle states having the same fixed life cycle state as a parent. When the state transition between fixed life cycle states is performed, the variable life cycle state at that time point is discarded, and the value of the variable life cycle state is automatically changed to the initial value of the variable life cycle state having the newly changed fixed life cycle state as the parent.

### <Hardware Configuration of Life Cycle State Management Module 100>

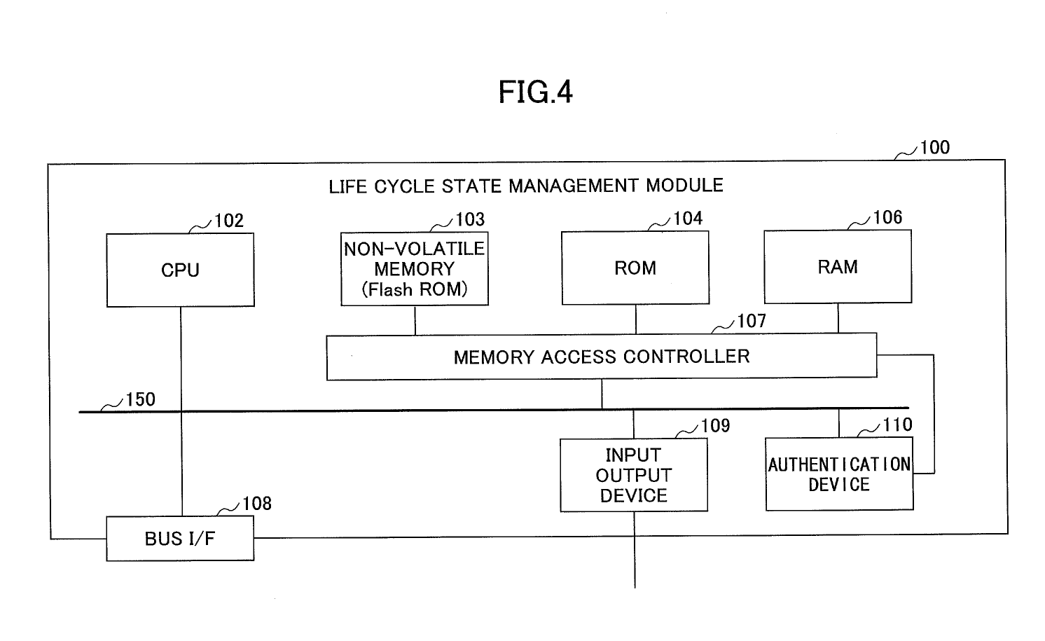

FIG. 4 is a hardware configuration diagram of the life cycle state management module 100 according to the present embodiment. As illustrated in FIG. 4, the life cycle state management module 100 according to the present embodiment includes a CPU (Central Processing Unit) 102, a memory access controller 107, a bus I/F 108, an input output device 109, and an authentication device 110 connected to each other by a bus line 150. A non-volatile memory 103, a ROM (Read-only Memory) 104, and a RAM (Random Access Memory) 106 are connected to the bus line 150 via the memory access controller 107. Particularly, the non-volatile memory 103 and the memory access controller 107 are included for realizing a configuration that is programmable according to different deliveries.

The CPU 102 provides programmed functions by reading user data, state data, control target data, and programs loaded in the non-volatile memory 103, the ROM 104, and the RAM 106, and executing the read data and programs.

The bus I/F 108 is an interface connecting to the bus 50 of the device (FIG. 2), and receives operations made to the device by the life cycle state management module 100 and accesses from control target modules.

The authentication device 110 determines whether the device user is an authorized user, when controlling the entire device (for example, control target modules of a vehicle). When the user is an unauthorized user, the life cycle state management module 100 switches into a state where it is not possible to use the entire device (vehicle). When the user is an authorized user, according to the group to which the user belongs, the memory access controller 107 provides a function of a program in accordance with the group, by limiting the accessible areas in the non-volatile memory 103, the ROM 104, and the RAM 106, or limiting the accessible control target modules, or even in a control target module that can be accessed, restricting the information that can be accessed in the accessible control target module in accordance with the state access control policy loaded in the non-volatile memory 103, the ROM 104, and the RAM 106. This is instructed from the authentication device 110 to the memory access controller 107 based on authentication results. The data determined by the authentication device 110 is input from the input output device 109. The authentication may be performed with an IC card reader, a device for placing device user certification data on a car key and inputting the data by inserting the key, a wired or wireless network device, or a smartphone. The procedures of authentication are described below.

The input output device 109 is not only used for user authentication, but is also used for performing data transfer for adding, correcting, and deleting data and programs in the non-volatile memory 103 and the RAM 106 for different deliveries. This may be a configuration of connecting with RS232C of a PC (Personal Computer) or a configuration of sending data from a smartphone by a network device.

Note that in FIG. 4, in order to physically distinguish an area where data is rewritable and an area where data is not rewritable, the non-volatile memory 103 and the ROM 104 are separately illustrated. If the areas are to be logically distinguished by applying an authority in which writing becomes inhibited after writing data once in a data area where rewriting is inhibited, only a non-volatile memory may suffice as the storage area of data. That is, any configuration is applicable as long as a rewritable area and a non-rewritable area are included in the life cycle state management module 100.

Note that the programs for the life cycle state management module 100 may be in files having an installable format or an executable format, and may be distributed by being recorded in a computer readable recording medium such as a CD-ROM.

### <Hardware Configuration of Other Control Modules>

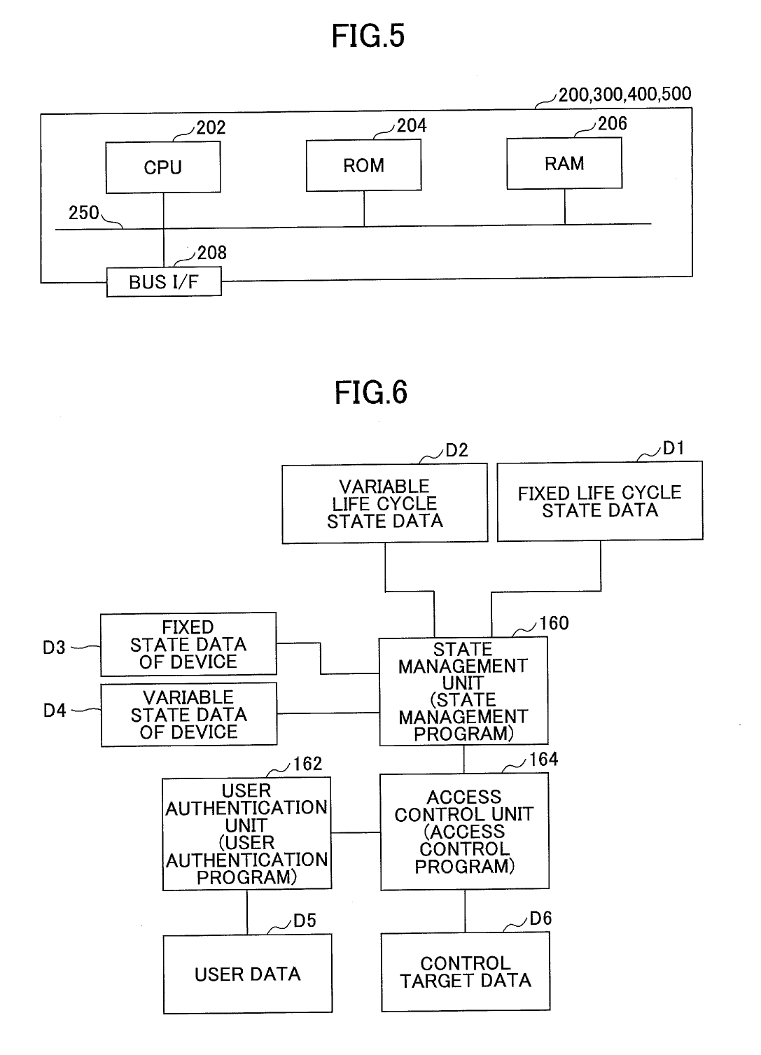

FIG. 5 is a hardware configuration diagram of the other control modules, that is, the drive control module 200, the engine control module 300, the navigation module 400, and the car-mounted camera module 500. These control modules include a CPU 202, a ROM 204, a RAM 206, and a bus I/F 208 that are connected to each other by a bus line 250.

### <Functional Configuration of Life Cycle State Management Module 100>

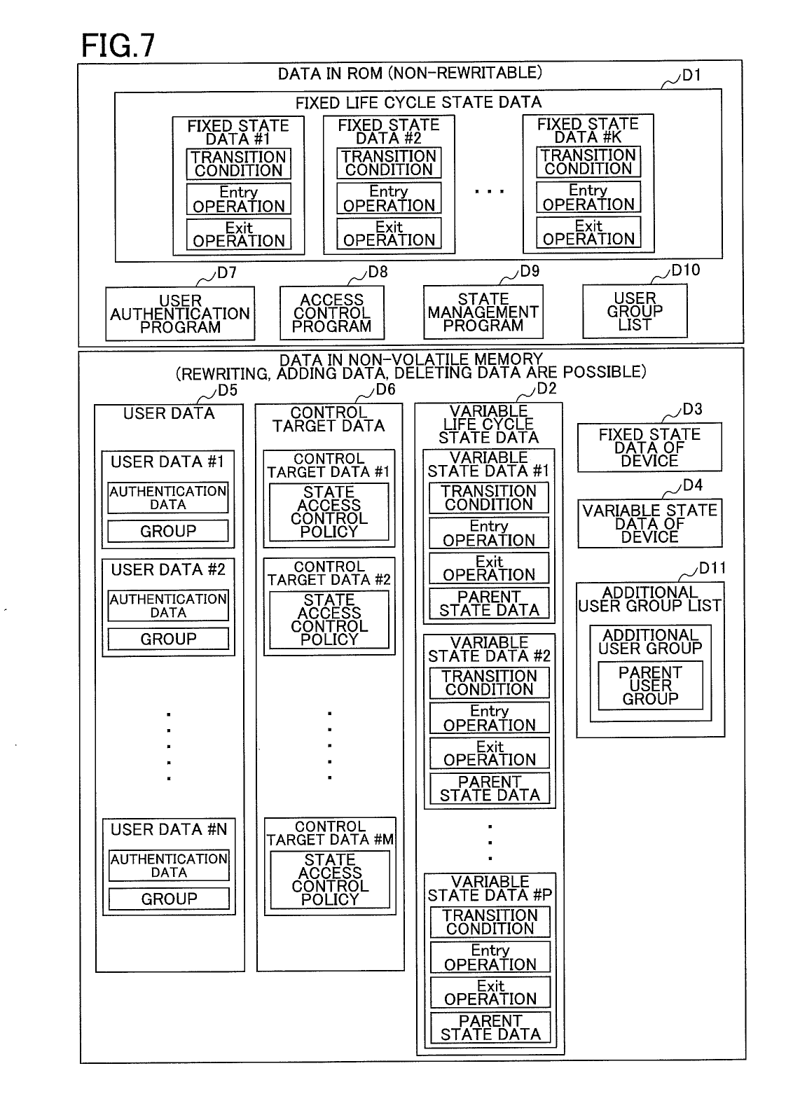

FIG. 6 is a functional block diagram of the life cycle state management module 100. FIG. 6 also illustrates the data used for processes, together with the functional block diagram of the life cycle state management module 100.

The life cycle state management module 100 includes a state management unit 160 realized by executing a state management program, a user authentication unit 162 realized by executing a user authentication program, and an access control unit 164 realized by executing an access control program. By operations by these units, it is possible to confirm the access control policy and the user data of all data for confirming the access authority to access the data, and then access control to the data is implemented upon confirmation.

The state management unit 160 can refer to fixed life cycle state data D1 of the device, variable life cycle state data D2 of the device, fixed state data of device D3, and variable state data of device D4 at the present time point, and reports the life cycle state at the time point of the access request. Furthermore, the state management unit 160 can acquire the data of each life cycle state. By this state management unit 160, it is possible to recognize the life cycle state at the time point, and the condition for transiting from each life cycle state, as information for access control.

The user authentication unit 162 operates to receive input of the authentication information of the user, and outputs the result of user authentication and the group of the user. The user authentication unit 162 refers to the user information input from the external I/F, and the user data D5, and searches for a user that can be authenticated. Here, the means for authentication is assumed to be certificate authentication or signature authentication in the case of authentication using a network I/F, or password authentication in the case of a user I/F; however, the authentication method is not limited. When the authentication is successful, a result indicating that the authentication is successful and the group present in the user data for which authentication is successful, are output.

The access control unit 164 includes a function of determining whether the user can access the data in a particular life cycle state, and refers to control target data D6. Each control target data item includes a state access control policy. The state access control policy stores a list of people who are able to access the data, indicating which user can access the data, and which group can access the data, in a particular life cycle. By referring to the control target data D6, the access control unit 164 is able to identify the user who can access each data (file) in a particular life cycle state. Details of the state access control policy are described below.

The access control unit 164 acquires a life cycle state by calling the state management unit 160, acquires the group of the corresponding user by calling the user authentication unit 162, and determines whether the user can access the data by checking the accessible group in the acquired life cycle state, with respect to the control target data.

### <Data Structure>

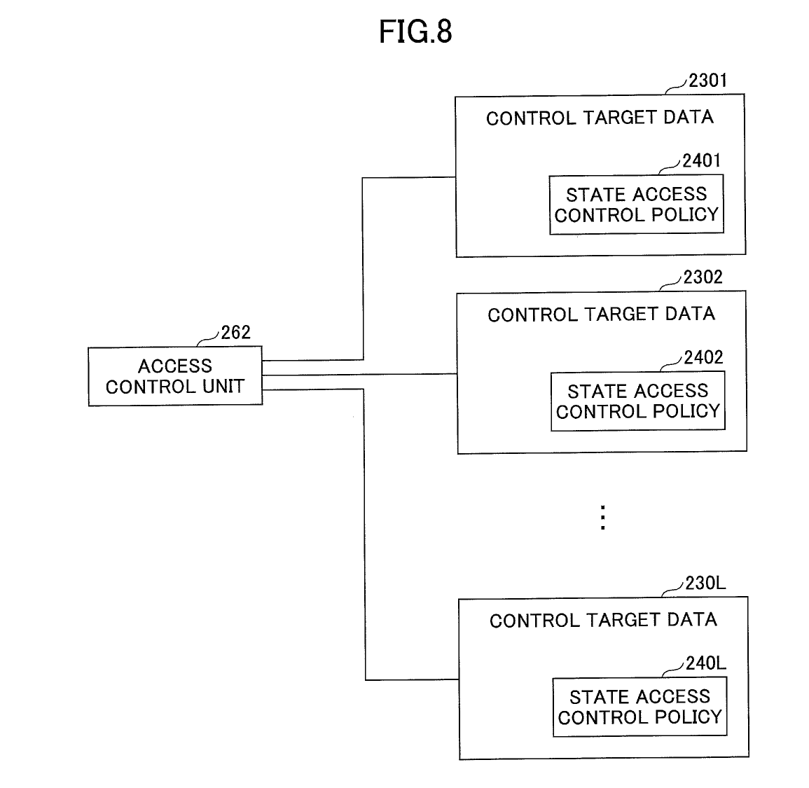

FIG. 7 illustrates an example of data stored in the life cycle state management module 100. The data can be roughly divided into two types, i.e., not rewritable data in the ROM (hereinafter, “non-rewritable data”), and data for which rewriting, adding, and deleting are possible, in the non-volatile memory (hereinafter, “rewritable data”). According to the configuration of FIG. 4, the non-rewritable data is stored in the ROM 104 and the rewritable data is stored in the non-volatile memory 103.

As non-rewritable data, there are at least fixed life cycle state data D1, a user authentication program D7, an access control program D8, a state management program D9, and a user group list D10. Furthermore, as rewritable data, there are at least user data D5, control target data D6, variable life cycle state data D2, fixed state data of device D3, variable state data of device D4, and an additional user group list D11. These data items are used to realize access control for each user by software; the correlative relationship between data from the viewpoint of software is described below.

In the fixed life cycle state data D1, an assembly of states that may be fixed life cycle states is managed as fixed state data. Each fixed state data item includes a transition condition, an entry operation, and an exit operation. The transition condition describes a condition that is to be satisfied when state transition occurs between fixed life cycle states, and describes a transition condition that is necessary for performing state transition while maintaining security. The entry operation describes the process to be executed when transiting to a state, when transiting from a particular fixed life cycle state. The entry operation describes operations to be performed for maintaining safety of the device in the state after transition, and the operations are forcibly performed at the same time as state transition such that loopholes in security are prevented from being formed. The exit operation provides functions such as deleting information that is not to remain after the state transition, and setting write inhibit authority for information that is not to be overwritten, when changing from the fixed life cycle state to another fixed life cycle state. These are all fixed information items, and when performing fixed life cycle state transition, functions are provided according to the respective data items and restrictions are forcibly executed, thereby assuring security.

As programs of non-rewritable software, there are the user authentication program D7, the access control program D8, and the state management program D9. Details of the functions provided by these programs are described below. These programs provide an access control function when a particular user attempts to access data. Thus, by placing these programs as non-rewritable data, access control is applied with respect to all data accesses, and the programs themselves can be prevented from being tampered, which leads to assurance of security. Furthermore, the user group list D10 describes a list of authority levels given to the users, and the groups present in the user data D5 have to be groups present in the user group list D10.

As rewritable data, there are the user data D5 used as user information of access control, the control target data D6 that is the target of access control, the variable life cycle state data D2 that expresses the variable life cycle state, the fixed state data of device D3 that expresses the life cycle state of the device at the time point, the variable state data of device D4, and the additional user group list D11 including the added user group.

As for the rewritable data, rewriting is possible; however, authority confirmation according to access control is implemented for writing into all of the data, and therefore not all users can arbitrarily rewrite the data, and only some of the users having the access authority are able to rewrite only the data for which the user has an access authority.

Each item of the user data included in the user data D5 includes authentication data and a group. The authentication data is information used for user authentication. In the case of authentication using the network I/F, certificate signature authentication is assumed, and in the case of authentication using a user I/F, user name password authentication is assumed, and a plurality of authentication methods may be considered, and therefore there may be a plurality of types of authentication data, and a plurality of authentication methods may be managed by a single user data item. Furthermore, a group is for setting the type of authority held by the group to which the user belongs; for example, there may be groups such as device managers and device manufacturers. As the group set as user information, a plurality of groups may be set, such as the device manager and the device user. Furthermore, the group may be defined by an additional user group of the additional user group list D11. However, in the case of an additional user group, the parent user group always has to be set from the user group list D10. Furthermore, the parent user group that can be set in the additional user group has to be the parent group of the setting person himself, or a group having a weaker authority, and access control is applied when the setting person sets this in the device.

The object registered as the user data D6 need not be a person. For example, there may be a setting of a user group in which, when log information is periodically sent to an external server, the log information is sent to an external server upon automatically performing authentication, without a person's manual operation.

Each control target data item included in the control target data D6 has a state access control policy that is a table for identifying the group that can be subjected to access control Details of the state access control policy are described below.

The variable life cycle state included in the variable life cycle state data D2 has a transition condition, an entry operation, an exit operation, and parent state data. With respect to a transition condition, an entry operation, and an exit operation, the roles of the data are the same those of the fixed state data. However, the transition condition does not describe the state transition from a fixed life cycle state to a fixed life cycle state, but describes the transition condition from a variable life cycle state to a variable life cycle state. The parent state data is included in the variable life cycle state data, but is not included in the fixed life cycle state data; here, only one fixed life cycle state data name is described.

The fixed state data of device D3 and the variable state data of device D4 indicate the life cycle state at the time point of the entire device, and only one of each of these is managed in the entire device.

### <Functional Configuration of Other Control Modules>

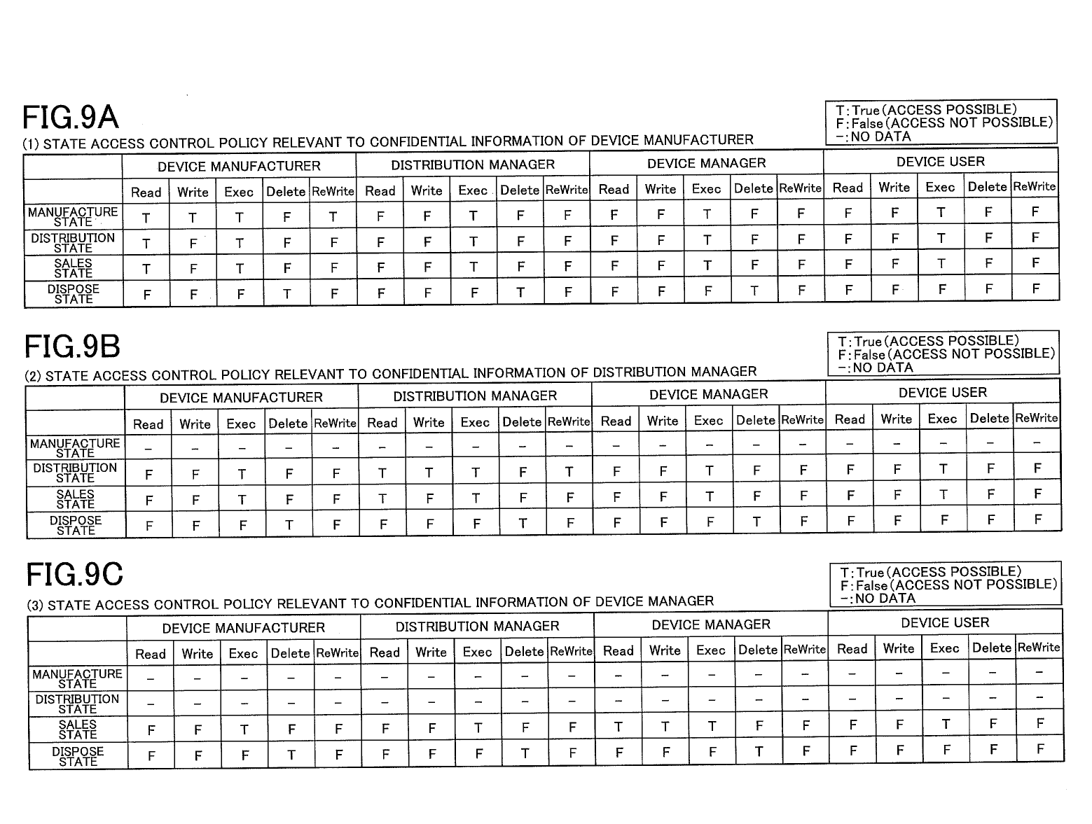

FIG. 8 is a functional block diagram of the other control modules, i.e., the drive control module 200, the engine control module 300, the navigation module 400, and the car-mounted camera module 500.

The control module includes an access control unit 262, and this access control unit 262 is a function or a function means that is realized as any one of the configuration elements in FIG. 5 operates according to an instruction from the CPU 202 according to an access control program, which is a drive control module-use program loaded from the ROM 204 to the RAM 206.

### <State Access Control Policy>

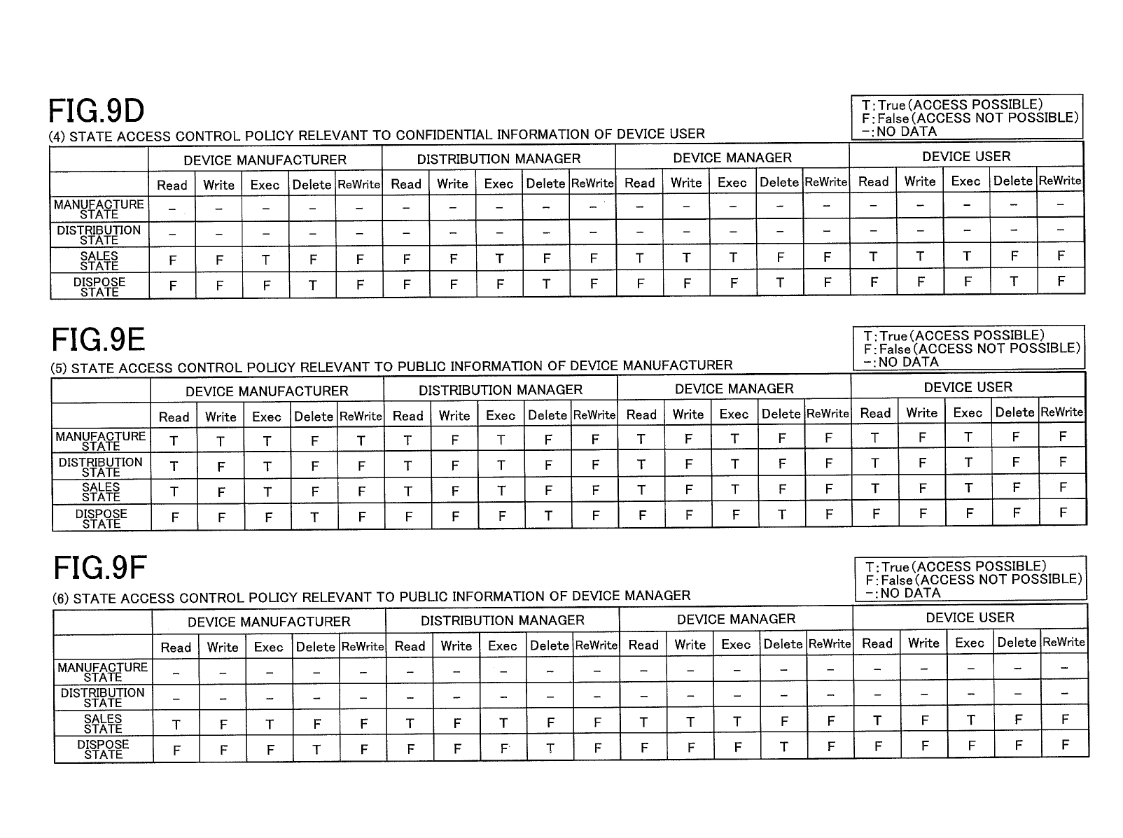

FIGS. 9A through 9F illustrate examples of state access control policies. Each item of the control target data item that becomes the management target by the life cycle state management module 100, includes a state access control policy. The state access control policy is a matrix table constituted by user groups and life cycle states of the device.

The access authority assigned to each user group includes the following types.

Read: Can read target control target data

Write: Can write target control target data (can generate)

Exec: Can use target control target data

Delete: Can delete target control target data

ReWrite: Can change target control target data

In FIGS. 9A through 9F, it is assumed that there are a device manufacturer, a distribution manager, a device manager, and a device user as user groups, and it is assumed that there are a manufacture state, a distribution state, a sales state, and a dispose state, as life cycle states. As a matter of simplification, these are all assumed to be fixed life cycle states, and no variable life cycle states are defined. Furthermore, as control target data, a description is given of an example of setting an access control policy of the confidential information held by each user group.

In FIG. 9A, the confidential information of the device manufacturer indicated as (1) is set in a device by the device manufacturer at the manufacture state. At this stage, only the device manufacturer is able to execute Read, Write, Exec, and ReWrite. Then, when the state transitions to the distribution state, the life cycle state management module 100 implements access control such that the device manufacturer cannot execute Write or ReWrite. Accordingly, it is possible to prevent the device manufacturer from tampering the confidential information in the device without permission, which leads to securing non-repudiation. The distribution manager, the device manager, and the device user can only execute Exec on the confidential information of the device manufacturer. However, there may be confidential information of the device manufacturer that only the device manufacturer has the Exec authority, such as a secret key for the signature of the device manufacturer. In the dispose state, the device manufacturer can dispose the confidential information of the device manufacturer. From the viewpoint of safety, a setting may be made such that the device manager can also dispose the information at the dispose state.

In FIG. 9E, the public information of the device manufacturer indicated as (5) is set in a device by the device manufacturer at the manufacture state. At this stage, only the device manufacturer is able to execute Read, Write, Exec, and ReWrite. Then, when the state transitions to the market operation state, the life cycle state management module 100 implements access control such that the device manufacturer cannot execute Write or ReWrite. Accordingly, it is possible to prevent the device manufacturer from tampering the public information in the device without permission, which leads to securing non-repudiation. The device, manager and the device user can only execute Read and Exec on the public information of the device manufacturer. In the dispose state, the device manufacturer can dispose the public information of the device manufacturer. From the viewpoint of safety, a setting may be made such that the device manager can also dispose the information at the dispose state.

In FIG. 9C, the confidential information of the device manager indicated as (3) is set in a device by the device manager at the market operation state. At this stage, only the device manager is able to execute Read, Write, and Exec. The device manufacturer and the device user can only execute Exec on the confidential information of the device manager. However, there may be confidential information of the device manager that only the device manager has the Exec authority, such as a secret key for the signature of the device manager. Accordingly, the confidential information held by the device manager can be protected by other users including the manufacturer of the device, and the life cycle state management module can be safely used. In the dispose state, the device manager can dispose the confidential information of the device manager. From the viewpoint of safety, a setting may be made such that the device manufacturer can also dispose the information at the dispose state.

Similarly, as for the public information of the device manager, the confidential information of the device user, and the public information of the device user (FIGS. 9B, 9D, 9F), the access control policy is constituted from the viewpoint of the non-repudiation of other uses and protection from other users. However, with respect to the confidential information of the device user, it should be determined as to whether the device manager can execute Read and Write, according to the operation of the life cycle state management module 100. When the manager has a strong authority, the device manager may be able to Read the confidential information of the device user; however, when the device manager and the device user have similar levels of authority, the device manager should not be able to Read the confidential information of the device user.

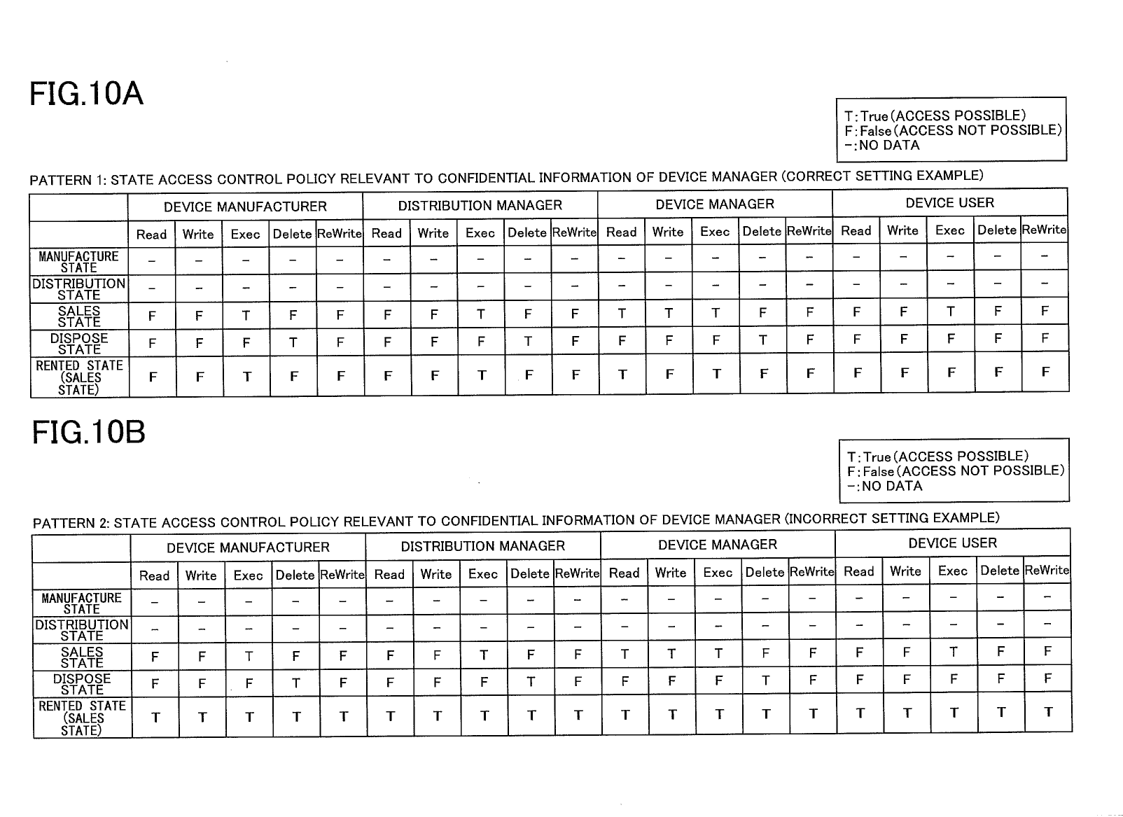

FIGS. 10A and 10B illustrate an example where a new state has been added to the state access control policy. FIGS. 10A and 10B illustrate an example where a variable life cycle state is newly defined, and the new state is added to the state access control policy, by a case of adding a variable life cycle state referred to as a “rented state” assuming that the device is rented. Note that this rented state is assumed to be a child state of the sales state.

In this case, the state access control policy may be arbitrarily set by the user who is adding the new state. However, because the rented state is a child state of the sales state, the access control cannot exceed the authority of a sales state. Pattern 1 of FIG. 10A is a correct setting example, where access is possible within the necessary range.

As indicated in pattern 2 of FIG. 10B, assuming that there is a malicious user who sets the state access control policy with respect to the variable life cycle state to be as weak as possible, access control is performed for the fixed life cycle state, and therefore it is possible to maintain a security strength that is at least the same as that of the fixed life cycle state.

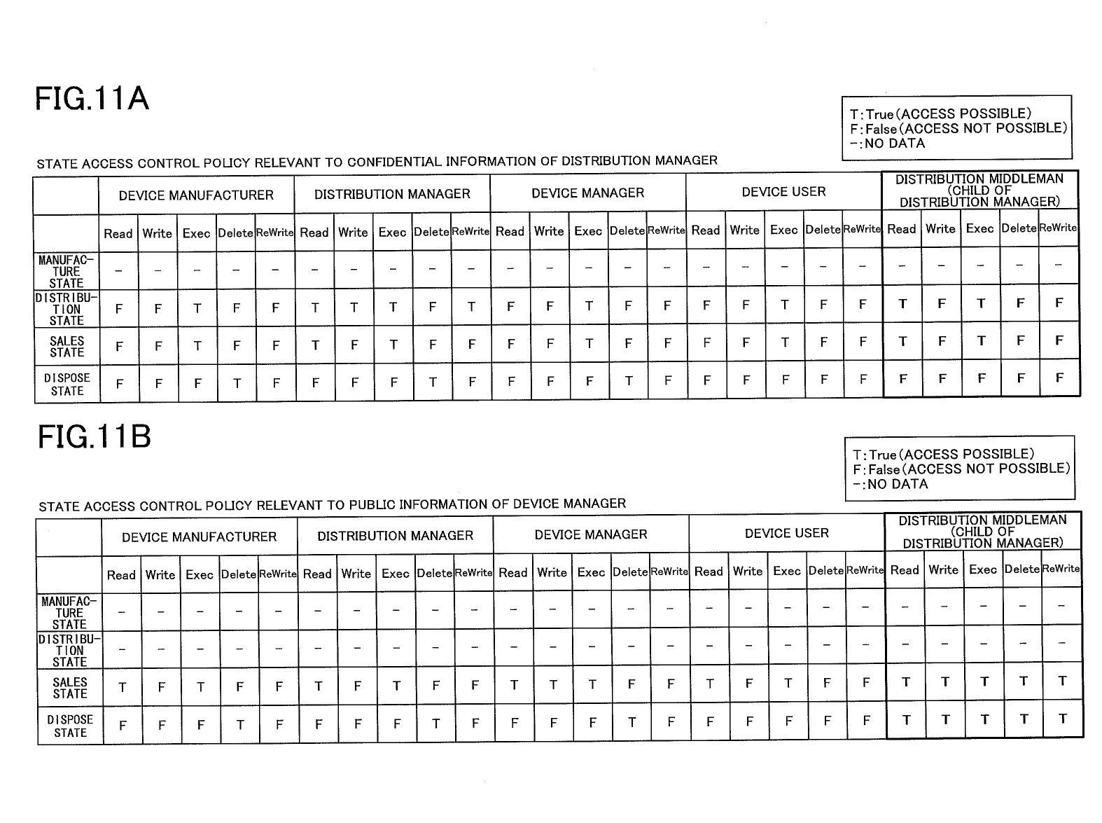

FIGS. 11A and 11B illustrate an example where a new group has been added to the state access control policy. In FIGS. 11A and 11B, a group of a “distribution middleman” is added as a child of “distribution manager”, as indicated on the right edge. As described above, there may be a case of newly defining a user group and adding the new group to the state access control policy. Similar to the case of FIGS. 10A and 10B, there is a parent user group, and therefore even if the weakest setting as made, it is possible to maintain a security strength that is at least the same as that of a user group in the user group list.

### <Access Process to Control Target Data>

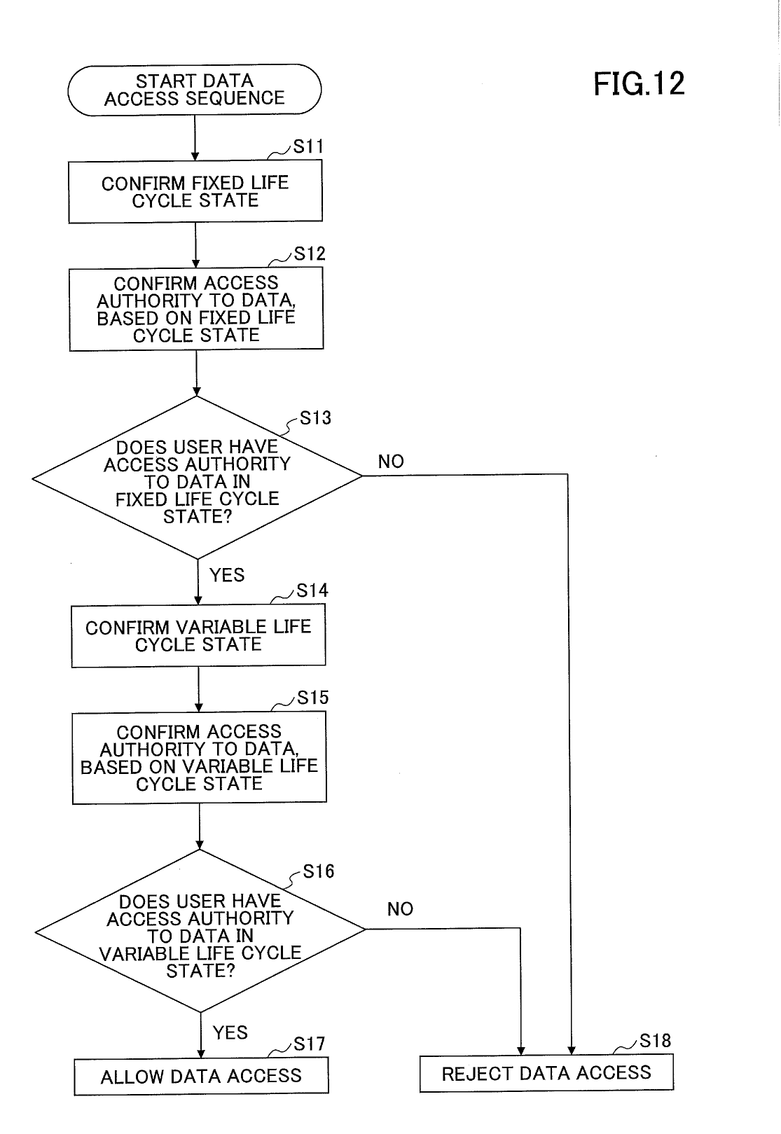

FIG. 12 is a flowchart illustrating an access process to control target data. In FIG. 12, when there is an access request from the user to the device to access the data, the process starts.

In step S11, the device calls the state management unit 160 (state management program), and the checks fixed life cycle state at the time point when the user has made the access request to the data.

Next, in step S12, the device confirms the access authority to the data based on the fixed life cycle state, and in step S13, the device checks whether the user has the authority for accessing the data. Details of this procedure are described below.

At this time, when the device determines that the user is not able to access the data, in step S18, the access to the data is rejected.

When the device determines that the user is able to access the data, in step S14, the device calls the state management unit 160, and checks the variable life cycle state at the time point when the user has made the access request to the data.

Next, in step S15, the device confirms the access authority to the data based on the variable life cycle state, and in step S16, the device checks whether the user has the authority for accessing the data. Details of this procedure are the same as the procedure of checking whether the user has the authority for accessing the data in the fixed life cycle state, and are described below.

At this time, when the device determines that the user is not able to access the data, in step S18, the access to the data is rejected. When the device determines that the user is able to access the data, in step S17, the device allows data access.

The order of processes indicated in the flowchart of FIG. 12 is not limited to the above and may be changed according to need.

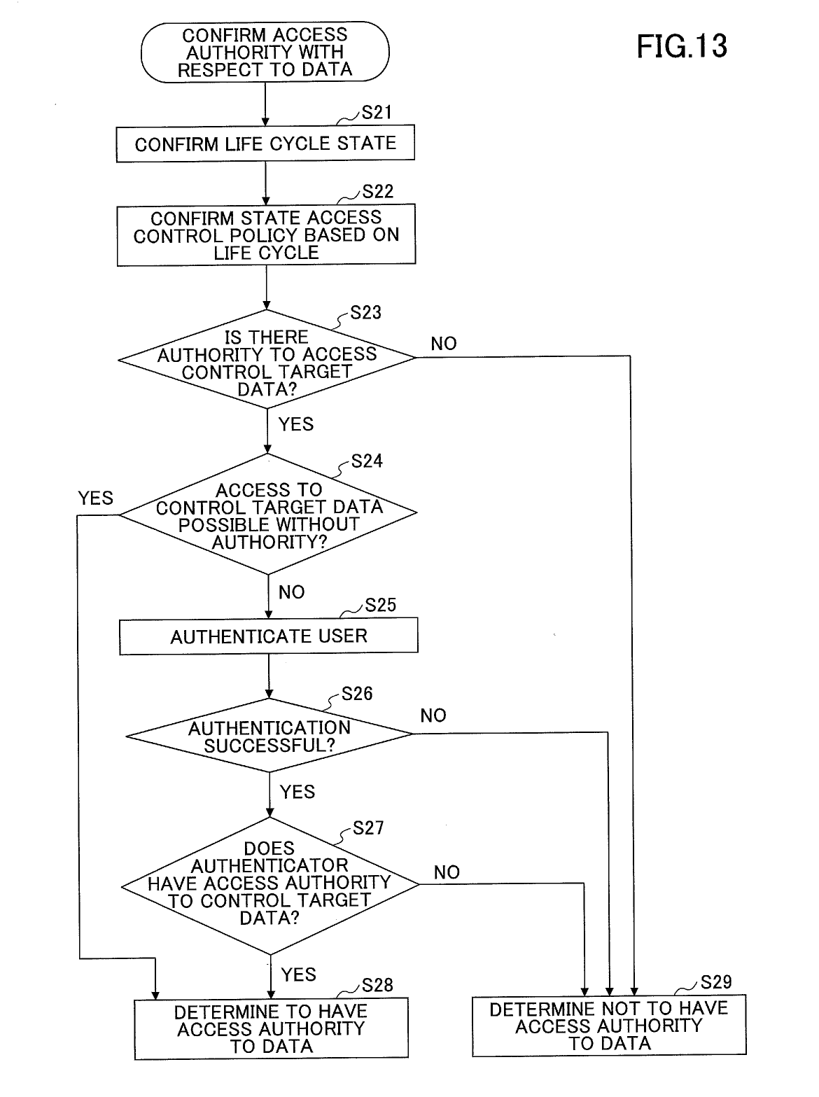

FIG. 13 is a flowchart of a process for checking whether the user has an access authority to the data under the life cycle state management. When the device receives a request to access the control target data, the device calls the access control function, and determines whether data access is authorized or rejected. The access control function is called two times for confirming the access control in the fixed life cycle state and for confirming access control in the variable life cycle state, and the processes are the same.

In FIG. 13, when an access request to control target data is made, in step S21, the access control function calls the state management function for confirming the present life cycle state. According to the call, the state management function sends the contents of the state data of the device at the time point when an access request to the control target data is made. At this time, when checking the fixed life cycle state data as life cycle state data, the fixed state data of the device is checked, and when checking the variable life cycle state data, the variable state data of the device is checked.

Next, after the access control function confirms the life cycle state data, in step S22, the access control function confirms the state access policy of the control target data that is the access target.

Next, in step S23, the access control function confirms whether there is authority for accessing the data from the state access policy.

When there is no user who can access the data, in step S29, the data to the access is rejected before authenticating the user. In one example, when there is public key information of the manufacturer as a file for which file writing is not allowed, the write access request to such a file is rejected.

Furthermore, when there is a user who can access the data, in step S24, the access control function confirms whether access control is applied to the data access according to a user group from the state access policy.

When access control is not applied to the data, in step S28, the access control function determines that the user has data access authority, and the user can access the data without user authentication. For example, in the case of file access for confirming the state access policy, the access request is allowed without confirming the user.

When access control is applied to the data access according to a user group from the state access policy, and confirmation of the user group is needed, in step S25, user authentication is performed by using the user authentication function. The authentication requires the input of the user's identifier and the user's authentication information, and the bus I/F 108 (FIG. 8) is used as an input unit for the user to input authentication information. The authentication information that is used depends on the input device connected to the bus I/F 108. For example, authentication may be performed by input of a user ID and a password. Furthermore, the input of the user's authentication information may be input at the time when the data access sequence starts, instead of in step S25.

When the authentication is successful in step S26, the user authentication function sends the group of the authenticated user to the access control function. This group may be defined in the user group list or defined in the additional user group list; however, in the case of the additional user group list, the additional user group is to be always confirmed after confirming the access authority of the parent group.

When the authentication is unsuccessful, the unsuccessful authentication result is sent to the access control function. When the access control function receives the unsuccessful authentication result, in step S29, the access control function determines that the user does not have a data access authority, and rejects the file access.

When the authentication is successful, in step S27, the access control function confirms whether the authenticated user can access the file, from the group of the authenticated user and the state access policy.

When the access control function determines that access to the file is possible, in step S28, the access control function determines that the user has a data access authority. Otherwise, in step S29, the access control function determines that the user does not have a data access authority.

The order of the processes illustrated in the flowchart of FIG. 13 is not limited to the above and may be changed according to need.

### <Process of Changing Life Cycle>

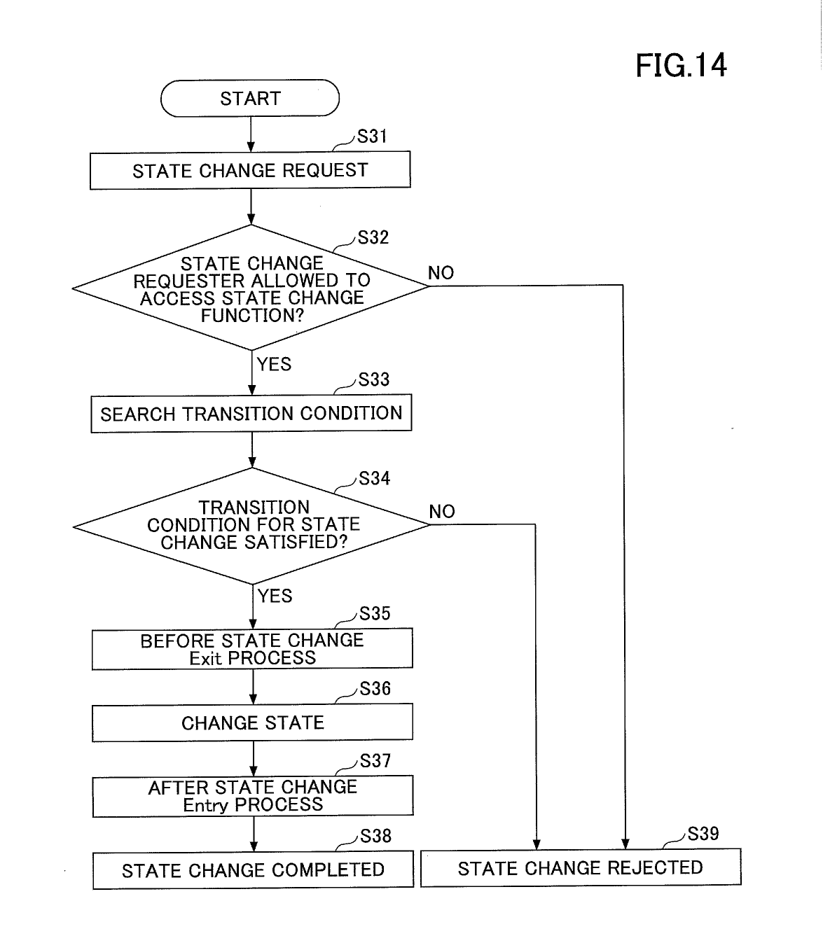

FIG. 14 illustrates a process of changing the life cycle state.

In step S31, the access control unit 164 of the life cycle state management module 100 receives a request to change the life cycle state (hereinafter, “state change request”).

In step S32, the access control unit 164 of the life cycle state management module 100 determines whether the accessing person that has made the state change request is the person for whom access has been allowed. The access control unit 164 performs a process of changing the life cycle state according to the state change request after implementing access control to the data. Specifically, the access control unit 164 executes an access process to the control target data illustrated in FIG. 12, when the state change request is received. The access control unit 164 performs a process of changing the life cycle state when access to the control target data is authorized, and when access is not authorized, the access control unit 164 rejects the process of changing the life cycle state.

In step S33, when the accessing person who has made the state change request in step S32 is a person for whom access is allowed, the state management unit 160 searches the transition condition. When the state change request is received, the access control unit 164 calls the state management unit 160, and requests a report of the transition condition in the state when the state change request has been made. The state management unit 160 reports the transition condition according to request for the report of the transition condition from the access control unit 164. The transition condition is that particular data exists, or certain data satisfies a particular format, etc. Here, as one example, a description is given of a case where the transition condition is to acquire the hash values of all data stored in the ROM 104, and to confirm that the data has not been tampered.

In step S34, the access control unit 164 determines whether the transition condition for state change is satisfied, based on the transition condition reported from the state management unit 160. Here, the transition condition is to acquire the hash values of all data stored in the ROM 104, and to confirm that the data has not been tampered, and therefore the access control unit 164 acquires the hash values of all data stored in the ROM 104 such as the control target data 1301-130M, and determines whether the data has been tampered, to determine whether the transition condition of state change is satisfied.

In step S35, when it is determined that the data has not been tampered in step S34, that is, when the state change condition is satisfied, the access control unit 164 performs a process of exiting from the state before state change. When the state change condition is satisfied, the access control unit 164 calls the state management unit 160, and requests the state management unit 160 to report the exit operation of the state data before state transition. The state management unit 160 reports the exit operation of the state data before state transition, according to the request to report the exit operation from the access control unit 164. The access control unit 164 performs an exit process according to the exit operation reported from the state management unit 160. By performing the exit process, in changing the life cycle state, it is possible to erase information if leaving the information when shifting to the next state would lead to vulnerability in security, or it is possible to rewrite such information. Examples of an exit process would be to delete log data leading to personal information of a major user of the device in the previous life cycle state, and to make an unwritable setting for preventing tampering of the secret key.

After the exit process is performed in step S35, in step S36, the access control unit 164 performs state change. The access control unit 164 reports the change of the state to the state management unit 160. When the change in the state is reported from the access control unit 164, the state management unit 160 transitions the state that is the management target, by replacing the contents stored as the present state with the requested state.

In step S37, the entry process to the state after state change is performed. After the state change, the access control unit 164 calls the state management unit 160, and requests the entry operation. The state management unit 160 reports the entry operation according to the request to report the entry operation from the access control unit 164. The access control unit 164 performs the entry process according to the entry operation reported from the state management unit 160. In the entry process, as a process for safely using the life cycle after state change, the initial setting of security information is made. One example is to perform a process of automatically generating a key by the device, in a case where a setting of a key for communication is needed.

After the entry process is performed in step S37, in step S38, the state change is completed.

When it is determined in step S32 that the accessing person who made the state change request is not a person for whom access has been allowed, or when it is determined in step S34 that the data has been tampered, in step S39, the access control unit 164 rejects the state change request.

The order of processes indicated in the flowchart of FIG. 14 is not limited to the above and may be changed according to need.

### <Specific Example of Using Variable Life Cycle State>

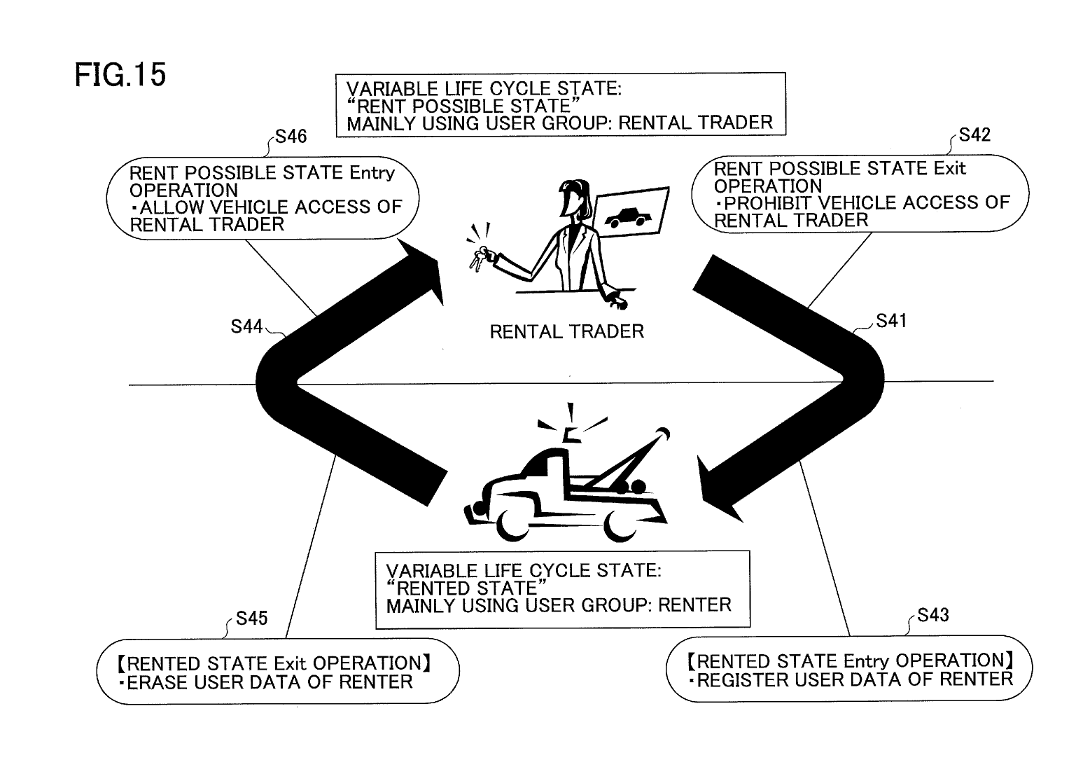

FIG. 15 illustrates a specific example of using the variable life cycle state, which is applied to a safe operation by using the life cycle state management when a vehicle is operated as a rental car.

In FIG. 15, it is assumed that market operation is already performed on the vehicle itself and the vehicle is in a sales state, and that a variable life cycle state is to be added and a user group is to be added. In FIG. 15, “rent possible state” and “rented state” are defined as variable life cycle states. The rent possible state is a state where the rental trader (dealer) of rental cars is holding the vehicle, and the rented state is a state where the vehicle is being rented out to a specific renting person. Furthermore, as the main users (groups), a group of rental traders and a group of renting persons are defined. Both the rent possible state and the rented state are defined as variable life cycle states having the sales state as the parent, and furthermore, the rental traders and the renting persons are defined as groups having the device manager as the parent.

For example, in a rent possible state, the rental trader needs to freely handle the vehicle, and therefore the rental trader has to be able to access the functions and data relevant to the operation of the vehicle. However, in a rented state, there may be cases where information, which is not to be open the rental trader, is handled in the vehicle. For example, when the renting person uses the navigation system in the rented state, the personal information indicating when and where the renting person attempted to go, may remain as history of the navigation system. This information is not information that the rental trader can see without permission. That is, in the rental car business, the rental trader needs to have different access authorities before and after renting out a vehicle, and the rental trader needs to have a weaker data access authority with respect to a vehicle that has been rented out.

Conversely, the renting person most likely wants to use the navigation system without any functional restrictions while the renting person is renting the vehicle, and it is more convenient to be able to search the navigation system from history information after inputting the address of his own house once, instead of having to input the address every time the renting person uses the navigation system. However, it is not preferable for the history of the navigation to be remaining in the vehicle, after returning the vehicle to the rental trader. That is, it is preferable that the renting person has a strong access authority to data such as the history log while the renting person is renting the vehicle, and that the data is deleted when the vehicle is returned.

Accordingly, when transiting from the rent possible state to the rented state (step S41), first, by the exit operation from the rent possible state, a restriction is applied to access to the vehicle by the rental trader (step S42). This restriction defines operations for prohibiting access to the navigation system, to prevent the rental trader from stealing the information of the renting person after renting out the vehicle. Next, as an entry operation to the rented state, the user data of the renting person is registered (step S43). By performing this operation, while the rental car is being rented out, the functions in the vehicle can be customized by being associated with the user data, so that the renting person can use the vehicle as if it was his own car. For example, a function of registering specific points in favorites of the navigation system and a history function of the navigation system can be used.

When transiting from the rented state to the rent possible state (step S44), as an exit operation from the rented state, the user data of the renting person is deleted (step S45). Furthermore, customized items associated with the user data, such as personal settings in the navigation system, are also deleted, such that no personal data of the renting person remains in the vehicle. Furthermore, at the same time, it is possible to prevent a situation where the renting person can access the vehicle after returning the vehicle.

Then, as an entry operation in the rent possible state, by setting the access restriction of the rental trader back to the original state (step S46), the rental trader is able to freely handle the vehicle only in the rent possible state.

Note that with respect to the person who is to perform the transitions of the respective life cycle states, the transition from the rent possible state to the rented state is preferably performed by the rental trader, and the transition from the rented state to the rent possible state is preferably performed by the renting person.

As described above, as it is possible to define the variable life cycle state, operations are possible without causing any inconvenience in regular usage, in a state where the security is maintained for both the renting person and the rental trader. These features are difficult to realize by existing patents; these features are made possible by the characteristic of a variable life cycle state that can be set back to the original state, and the characteristic that it is possible to add a new group and the groups can be given different authorities.

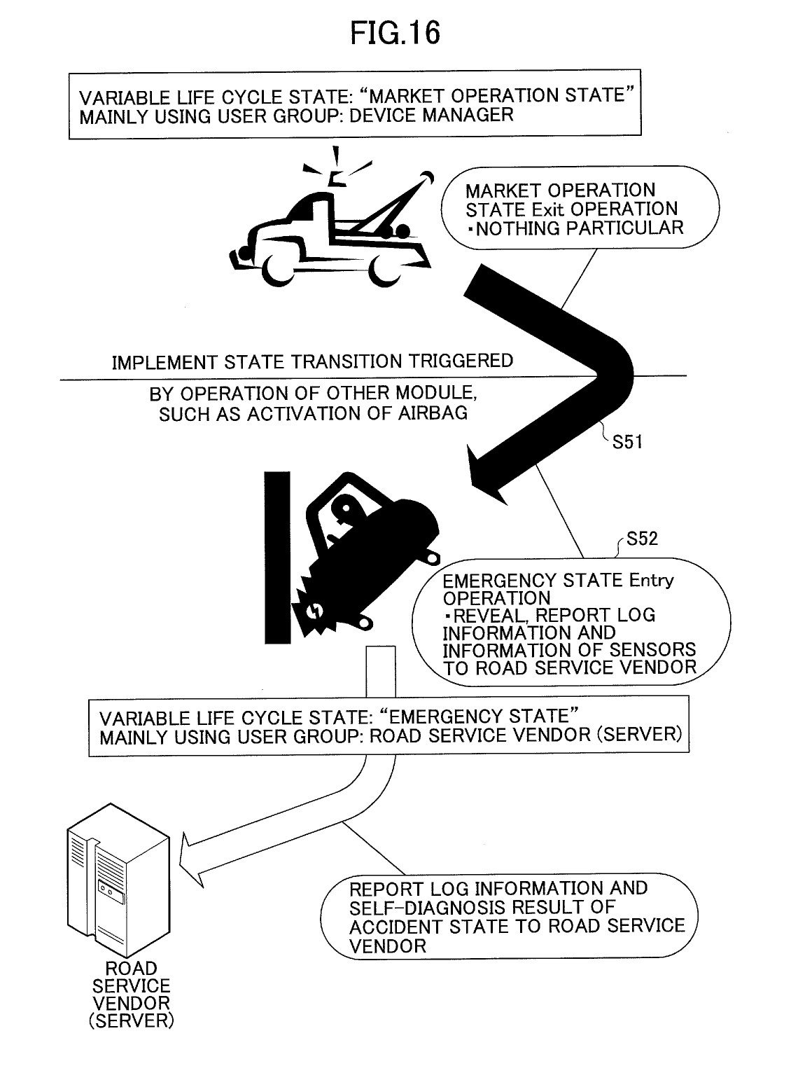

FIG. 16 illustrates another specific example of using the variable life cycle state, which is applied to an automatic accident reporting system using the life cycle state management when the vehicle has an accident, as an example in which an object other than a person is set as the user.

In FIG. 16, the vehicle itself is already subjected to a market operation, and it is assumed that the vehicle is in a sales state. Furthermore, in this example, the state transition is not caused by a particular person but by the cooperation between devices such as other modules.

In FIG. 16, as variable life cycle states, a “market operation state” and an “emergency state” are defined. The market operation state is defined as a state in which the device manager is normally using the device, and the emergency state is defined as a state in which an emergency needs to be reported. Furthermore, as the main users (groups), a group of device managers and a group of road service vendors are defined. Both the market operation state and the emergency state are defined as variable life cycle states having the sales state as the parent, and furthermore, the road service vendors are defined as a group having the device user as the parent.

For example, in the market operation state, the device manager may not prefer to reveal the log information inside the vehicle more than necessary, even when a contract is made with the road service vendor. In this case, in the market operation state, by prohibiting any access to the log by the road service vendor, there is no concern of the data being looked at, and the strength of security is increased.

However, at the time of an accident (step S51), there is a need to quickly ask for rescue to the road service vendor, and therefore in the emergency state, a setting is made to reveal the log information and information of sensors in the vehicle for detecting the state of the accident, and to report the information to the road service vendor (step S52). Accordingly, when an accident occurs, the information is immediately reported to the road service vendor, and the road service vendor can estimate the degree of the accident from various sensor information items. Furthermore, by making a setting to perform automatic reporting in the emergency state, the function of reporting to the road service vendor can be locked in other states, and therefore it is possible to resolve problems such as erroneous reporting to the road service vendor and prank reporting. Furthermore, as the sensor results are automatically reported, the status of the accident can be objectively reported, without depending on the subjective view of a person.

In this example, the transition for shifting the state is not performed manually be a person. For example, the transition from the market operation state to the emergency state is triggered by the operation of another module (safety device), such as being triggered by the activation of the air bag. Operations by the cooperation between devices without any manual operations by a person, may also be a management module of the life cycle state transition.

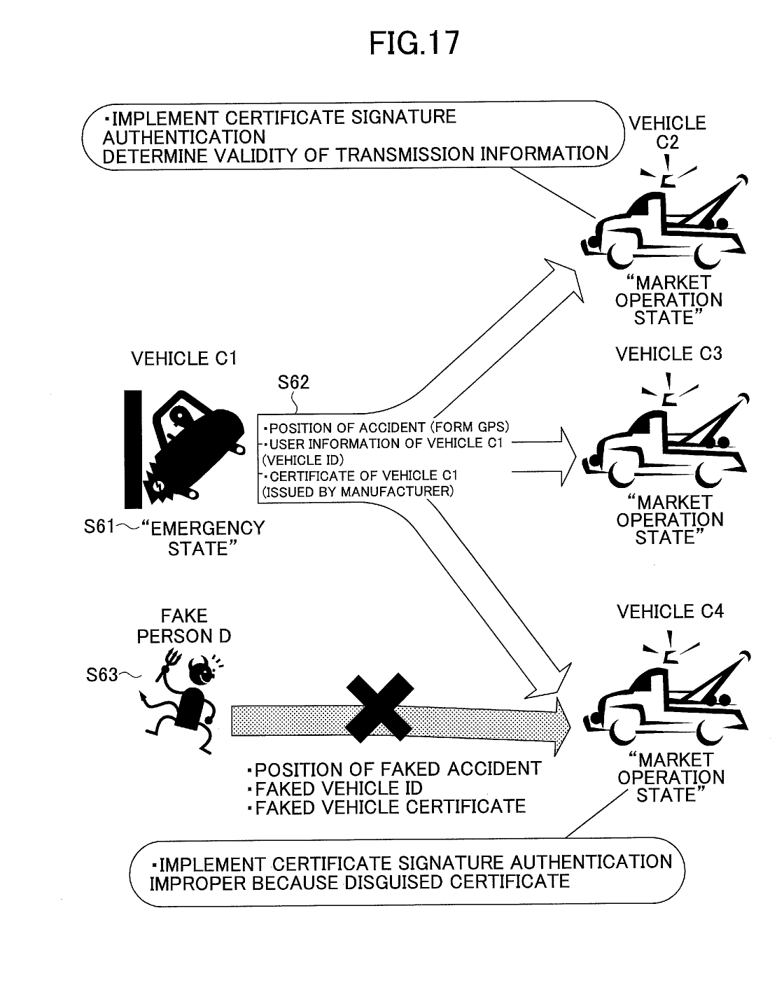

FIG. 17 illustrates yet another specific example of using the variable life cycle state, which is applied to an automatic accident reporting system using the life cycle state management when the vehicle has an accident, as a service that can be provided by using a plurality of life cycle management modules.

In FIG. 17, the object that reports the state of the accident of a vehicle, is another vehicle using another life cycle state management system.

When a vehicle C1 has an accident (step S61), in order to predict any danger in advance, data is sent to the respective vehicles for reporting danger, by using the accident position, the user ID of the vehicle C1, and the certificate of the vehicle C1 (step S62). At this time, by attaching a digital signature to the position of the accident and the user ID of the vehicle C1, the data is sent such that the vehicles C2 through C4 can authenticate the data.

When the data from the vehicle C1 is received, the vehicles C2 through C4 perform certificate signature authentication, and confirm the validity of the data. Accordingly, it is possible to quickly recognize the information of the accident, and respond by displaying the accident position on the navigation system and starting to search for a detour route.

The operations of the device as described above are enabled because the device is provided with an authentication function and the internal information of the device, which cannot be accessed even by the device user, is stored inside the device. By using an authentication function of the device, even when there is a fake person D who is attempting to disturb the traffic by a faked accident (step S63), if the certificate is not issued by a proper certificate issuing organization, the certificate will have a defect, and even when the vehicles receive the data of a faked certificate, the vehicles will not accept the certificate. Furthermore, setting can be made such that even the device manager cannot intentionally report an accident. Management is implemented to allow only the system of the device itself to make the signature using the certificate of the vehicle C1, and even the device manager is not authorized to make the signature, such that there is no way to convey the accident information outside, other than by automatic reporting.

Accordingly, by using the authentication function and the access control function, it is possible to supply a service assuming that security is protected.

### OVERVIEW

As described above, according to the present embodiment, in an embedded device for implementing access control in state transition based on life cycle states, consistent security can be maintained throughout the life cycle of the embedded device.

According to an aspect of the present invention, there is provided a control method executed by a computer that constitutes a management module installed in a device holding control target data inside the device, the control method including managing a life cycle state that the device is presently in; receiving authentication data, authenticating a user, and giving a response indicating a group to which the user belongs; acquiring a present life cycle state managed at the managing when an access request to access the control target data is received, authenticating the user and acquiring the group of the authenticated user, acquiring access possibility information based on the present life cycle state and the group of the user who has made the access request, the access possibility information being acquired from a state access control policy associated with the control target data, and controlling access to the control target data based on the access possibility information, wherein the managing includes managing a fixed life cycle state and a variable life cycle state having a parent that is one of the fixed life cycle states, wherein the variable life cycle state can be added, changed, or deleted, and the controlling includes implementing control with respect to the fixed life cycle state before the variable life cycle state.

The device and the management module are not limited to the specific embodiments described herein, and variations and modifications may be made without departing from the spirit and scope of the present invention. That is, the present embodiment should not be construed as being limited by the details of the specific examples or the accompanying drawings.

The present application is based on and claims the benefit of priority of Japanese Priority Patent Application No. 2014-184965, filed on Sep. 11, 2014, the entire contents of which are hereby incorporated herein by reference.

What is claimed is:

1. A device holding control target data inside the device, the device comprising:
a state management unit configured to manage a life cycle state that the device is presently in;
a user authentication unit configured to receive authentication data, authenticate a user, and give a response indicating a group to which the user belongs; and
an access control unit configured to
acquire a present life cycle state from the state management unit when an access request to access the control target data is received,
authenticate the user by the user authentication unit and acquire the group of the authenticated user,
acquire access possibility information based on the present life cycle state and the group of the user who has made the access request, the access possibility information being acquired from a state access control policy associated with the control target data, and
control access to the control target data based on the access possibility information, wherein
the state management unit manages a fixed life cycle state and a variable life cycle state having a parent that is one of the fixed life cycle states, wherein the variable life cycle state can be added, changed, or deleted, and
the access control unit implements control with respect to the fixed life cycle state before the variable life cycle state.

2. The device according to claim 1, wherein
the user authentication unit manages a fixed group and an additional group whose parent is the fixed group, wherein the additional group can be added, changed, or deleted,

3. The device according to claim 1, wherein
the state management unit manages state data associated with the life cycle state, the state data including one or more of a transition condition for performing state change, a definition of a process to be forcibly executed when performing state change, and a definition of a process to be forcibly executed when transiting to a next state.

4. The device according to claim 1, wherein
the state management unit changes the life cycle state by being triggered by a human-induced input operation or an automatic detection operation.

5. The device according to claim 1, further comprising:
an authentication unit configured to determine whether another device is a valid by performing authentication, when communicating with the other device.

6. A management module installed in a device holding control target data inside the device, the management module comprising:
a state management unit configured to manage a life cycle state that the device is presently in;
a user authentication unit configured to receive authentication data, authenticate a user, and give a response indicating a group to which the user belongs; and
an access control unit configured to
acquire a present life cycle state from the state management unit when an access request to access the control target data is received,
authenticate the user by the user authentication unit and acquire the group of the authenticated user,
acquire access possibility information based on the present life cycle state and the group of the user who has made the access request, the access possibility information being acquired from a state access control policy associated with the control target data, and
control access to the control target data based on the access possibility information, wherein
the state management unit manages a fixed life cycle state and a variable life cycle state having a parent that is one of the fixed life cycle states, wherein the variable life cycle state can be added, changed, or deleted, and
the access control unit implements control with respect to the fixed life cycle state before the variable life cycle state.

7. A non-transitory computer-readable recording medium storing a program that causes a computer that constitutes a management module installed in a device holding control target data inside the device, to execute a process comprising:
managing a life cycle state that the device is presently in;
receiving authentication data,
authenticating a user, and giving a response indicating a group to which the user belongs;
acquiring a present life cycle state managed at the managing when an access request to access the control target data is received, authenticating the user and acquiring the group of the authenticated user, acquiring access possibility information based on the present life cycle state and the group of the user who has made the access request, the access possibility information being acquired from a state access control policy associated with the control target data, and controlling access to the control target data based on the access possibility information, wherein
the managing includes managing a fixed life cycle state and a variable life cycle state having a parent that is one of the fixed life cycle states, wherein the variable life cycle state can be added, changed, or deleted, and
the controlling includes implementing control with respect to the fixed life cycle state before the variable life cycle state.
